(19) United States
(12) Patent Application Publication
(10) Pub. No.: US 2006/0010429 A1
(43) Pub. Date: Jan. 12, 2006

(54) Method, system and program for model based software development with test case generation and evaluation

(75) Inventor: Hiroyuki Ihara, Anjo-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/156,734

(22) Filed: Jun. 21, 2005

(30) Foreign Application Priority Data
Jul. 8, 2004 (JP) 2004-201861

(51) Int. Cl. G06F 9/44

(52) U.S. Cl. 717/126

(57) ABSTRACT

A test case is generated based on a model of a control system as well as a source code generated from the model by using a model based software development method. Information on an attribute of the model such as a range of input to the model is evaluated and used for generating the test case. A simulation result of the model besides an input data and a content of the source code are utilized for enhancing coverage of the test case.

### CROSS REFERENCE TO RELATED APPLICATION

This application is based on and claims the benefit of priority of Japanese Patent Application No. 2004-201861 filed on Jul. 8, 2004, the disclosure of which is incorporated herein by reference.

### FIELD OF THE INVENTION

The present invention relates to method and system for model based development of software, and more specifically to method and system for model based development using automated test case generation and validity check.

### BACKGROUND OF THE INVENTION

In recent years, a program for controlling an engine ECU or the like in an automotive vehicle is developed by using a methodology that is called “Model Based Software Development.” In this kind of methodology, a software developer uses a “model” for designing functionality of the program, because the model can be much more intuitively created and manipulated than a source code in terms of clarity and correctness (refer to Japanese Patent Document JP-A-2000-20291).

The developer develops the program by using software products for the model based development environment on a workstation, a personal computer or the like. The model is defined and used to simulate an input, an output and a process used in the program. The model is also used to automatically generate a source code of the program.

The software products for the model based development environment includes tools such as a source code generation tool, a simulation tool and the like. These tools are used as components of an integrated software development environment. Matlab (registered trademark) from Mathwork (registered trademark) is an example of the development environment used for the model based development environment. The input and output are modeled and simulated by using a Simulink (registered trademark) module in the development environment.

The model includes a block as a unit of functions corresponding to data input, data output and data process, and a connecting line between the blocks as a representation of input and output of data from the function. The blocks and the connection lines are combined to graphically represent the program used to control the automotive vehicle or the like.

Quality assurance of the model is a part of an intended functionality of the integrated model base development environment. The quality of the model, and the program generated therefrom, is evaluated by using various criteria in terms of coverage (ratio of executed number of branches in the model) and the like. The quality of the model is also evaluated by a criterion whether the input and output of the program is correctly defined in the source code of the program.

The quality of the source code is examined and evaluated by using a tool such as an Automatic Test case Generation (ATG) tool. The ATG tool analyzes contents of the source code, e.g., a branch condition of an instruction, and then generates a set of input data (i.e., a test case) that creates as many branch conditions as possible.

However, the test case solely generated from the source code in the integrated model based development environment does not necessarily reflect attributes of an input data such as a range of data, an accuracy or the like that are expected by the developer at a time of model creation. That is, the test case generated by analyzing the source code may include an unnecessary part or may lack a necessary part in terms of fully exhaustive execution of the source code.

### SUMMARY OF THE INVENTION

In view of the above-described problems, it is an object of the present invention to provide a method, a system and a program for generating a test case for a test of a generated source code based on a model, the test case that fully reflects an intended specification of the model designed by a developer.

It is another object of the present invention to provide a method, a system and a program for evaluating the generated source code based on a simulation of the model by using the test case as an input data for the simulation when the test case is generated based on the generated source code.

According to the present invention, the method, i.e., the system and/or the program implementing the method create the test case based on the generated source code from the model besides utilizing information stored in the model. That is, content of the source code and retrieved information are utilized for making the test case more concise and exhaustive. Therefore, the test case fully reflects the intended specification designed by the developer.

More practically, the retrieved information includes an upper limit of an input data and/or a lower limit of the input data. The retrieved information may include accuracy of the input data. In this manner, the test case takes boundary conditions such as the upper and/or lower limit of the input data with its accuracy into account.

The method described above may take a form of a program as well as being implemented as a function of a system. The program may serve as a component of the model based development environment.

A simulation result report yielded in the simulation of the model are used to create the test case as well as the generated source code from the model is in the present invention. In this manner, the test case reflects the intended specification of the model more precisely by taking the simulation result and the content of the source code into account.

More practically, information on a preceding model, that is, the model being executed prior to the execution of the subject model, is used as the simulation result report to generate the test case. The information on the preceding model such as the output data from the preceding model may be taken into account when the subject model uses the output data of the preceding model as an input data. The input data fed to the subject model for generating the source code is taken into consideration when the test case is generated accordingly.

The simulation result report may include at least one of the upper limit and the lower limit of the input data. The test case reflects one of the upper limit and the lower limit of the input data in this manner.

The method described above may take a form of a program as well as being implemented as a function of a system. The program may server as a component of the model based development environment.

Evaluation of the generated source code is another object of the present invention. The source code is evaluated based on the simulation result report yielded from the simulation of the model. The simulation of the model is conducted by using the test case generated in the above-described manner. A system for the evaluation of the source code in the present invention may serve as a storage and display device of the simulation result. The evaluation system may be used to display a portion of the model that is not executed in the simulation using the test case as the input data.

The method described above may take a form of a program as well as being implemented as a function of a system. The program may server as a component of the model based development environment.

The present invention may be considered as a model based development method having following procedures. That is, a source code generation procedure based on the model representing control processes, a model information retrieval procedure, a test case generation procedure based on the generated source code and the model information, and a simulation execution procedure using the test case as the input data.

The present invention may also be considered as a model based development method having the following procedures. That is, a source code generation procedure based on the model representing control processes, a simulation execution procedure, a simulation result analysis procedure, a source code retrieval procedure, a simulation result retrieval procedure, and a test case generation procedure for generating the test case for the generated source code based on a content of the generated source code and a result of the simulation.

### BRIEF DESCRIPTION OF THE DRAWINGS

Other objects, features and advantages of the present invention will become more apparent from the following detailed description made with reference to the accompanying drawings, in which:

FIG. 1 is a block diagram of a personal computer in an embodiment of the present invention;

FIG. 2 is a block diagram of a model based development environment executed in the personal computer;

FIG. 3 is an exemplary diagram of a model used in the embodiment of the present invention;

FIG. 4 is a list of C source code generated from the model in FIG. 3;

FIG. 5 is a flowchart of a simulation result analysis program;

FIG. 6 is a flowchart of an automatic test case generation program; and

FIG. 7 is a table of evaluation displayed by a result display program.

### DETAILED DESCRIPTION OF THE PREFERRED EMBODIMENTS

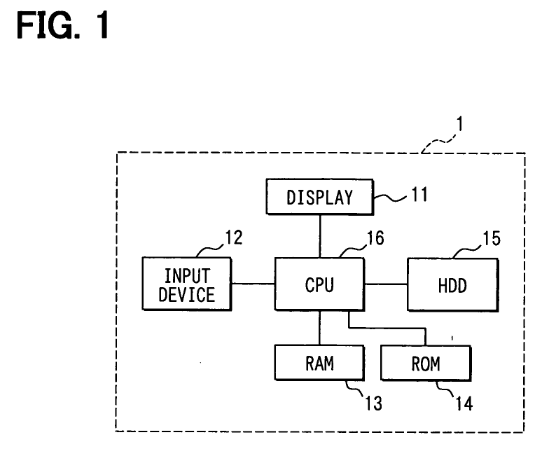

An embodiment of the present invention is described with reference to the drawings. FIG. 1 shows a block diagram of a personal computer 1 implementing a model generation system. The personal computer 1 includes a display 11, an input device 12, a RAM 13, a ROM 14, a HDD (hard disk drive) 15, a CPU (processor) 16 and the like.

The display 11 displays an image signal received from the CPU 16 for a user (developer) as an image. The input device 12 includes a keyboard, a mouse and the like. The input device 12 outputs an operation signal to the CPU 16 upon receiving a user operation.

The RAM 13 is a readable and writable volatile memory. The ROM 14 is a read-only non-volatile memory. The HDD 15 is a readable and writable non-volatile memory. The ROM 14 and the HDD 15 store a program and the like for retrieval and execution by the CPU 16. The HDD 15 also stores a model. The model is described later in detail.

The RAM 13 is used as a temporary memory area that temporarily stores the program retrieved from the ROM 14 and/or the HDD 15 and executed in the CPU 16. The RAM 13 also serves as the temporary memory area for storing a work data.

The CPU 16 initiates system operation of the personal computer 1 by executing a boot program stored in the ROM 14 when the personal computer 1 is turned on. The boot program executes an initialization process of the system operation by executing an operating system and other programs stored in the HDD 15. The CPU 16 controls the system operation based on a schedule and the like according to the operating system and the operation signal from the input device 12, and executes various programs stored in the HDD 15 as processes on the operating system while the personal computer 1 is running. The CPU 16 also controls reception of the operation signal from the input device 12, output of the image signal to the display 11, record and retrieval of the data to/from the RAM 13 and the HDD 15.

The CPU 16 in the present embodiment executes the programs described later to set up an integrated development environment for generating a C source code that is used in an automotive ECU based on a model described later in detail.

A “program” is used as a subject of operations that actually is executed and controlled by the CPU 16, and the “program” is considered as a type of method that is implemented in a computer such as an automotive ECU or the like for the purpose of directly controlling the computer.

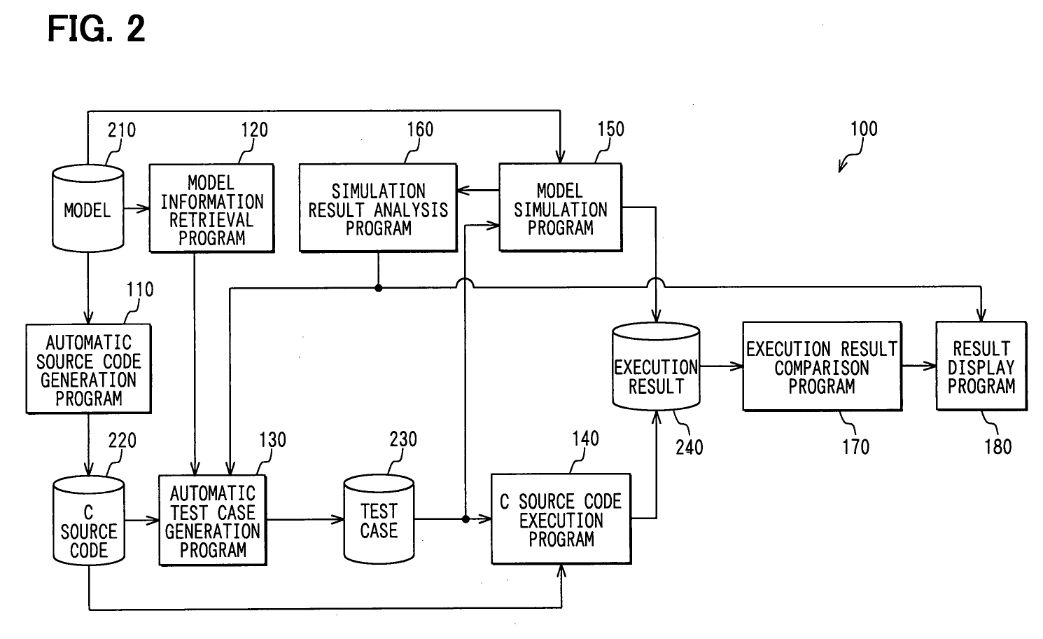

The FIG. 2 shows a block diagram of a model based development environment 100 executed in the personal computer 1. The model based development environment 100 includes an automatic code generation program 110, a model information retrieval program 120, an automatic test case generation program 130, a C source code execution program 140, a model simulation program 150, a simulation result analysis program 160, a result comparison program 170 and a result display program 180. These programs are executed under an execution instruction from the user by using the input device 12.

The automatic code generation program 110 retrieves a model 210 created by the user and stored in the HDD 15, and generates the C source code that stores instructions of inputting and outputting data represented by the model 210. The automatic code generation program is marketed, for example, as a product such as Real Time Workshop (registered trademark) from Mathworks (registered trademark). The model may be created by the user using a model creation program such as a model editor or the like. The model editor or the like may be included in the model based development environment 100.

The model and its feature are described with reference to the drawings. The model is representation of a process operation, an inputting operation and an outputting operation of data, each operation represented in a form of blocks in relation with a time series. The model uses a connecting line with the blocks as a representation of relationship such as an input and an output between those blocks. The model is used, for example, in a software product such as Simulink (registered trademark) from Mathworks (registered trademark).

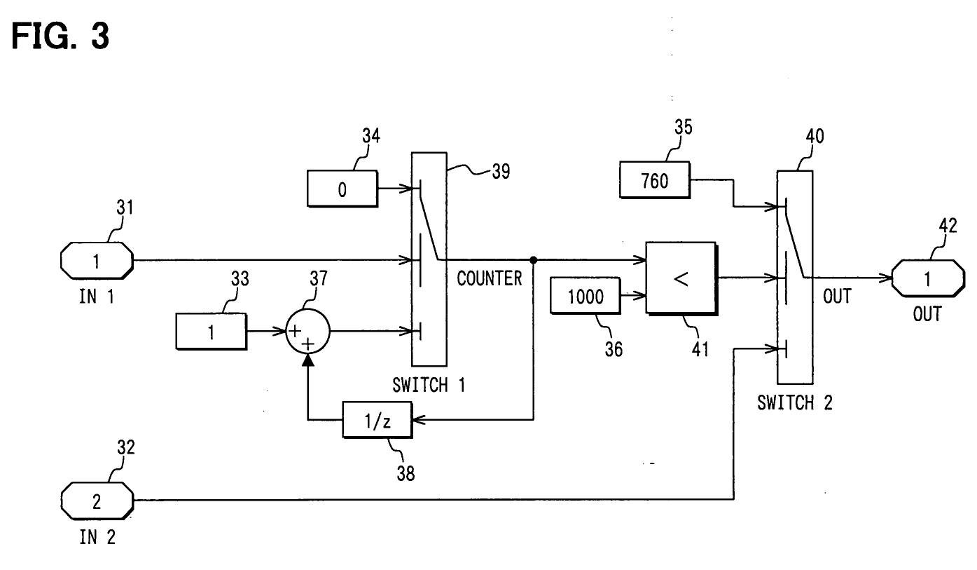

FIG. 3 shows an exemplary diagram of the model. Graphic forms 31 to 42 represent blocks and arrow lines between the blocks represent the connecting lines.

Input blocks 31, 32 represent a function that receives inputs of data from outside of the model and outputs the data to a pointed block by the connecting line toward a later step. Constant blocks 33 to 36 represent a function that outputs a constant value to the pointed block by the connecting line toward the later step. The constant value for each constant block is chosen and set by the developer respectively. An addition block 37 represents a function that outputs a result of addition of two values in the received data toward the later step. A delay block 38 has a function that outputs the received data from the connecting line after a predetermined delay time toward the later step.

Switch blocks 39, 40 represent a function that selectively outputs either of two selection inputs from the two connecting lines based on a value of a condition input from another connecting line. The value of the condition input is either 1 or other. The upper and lower connecting lines attached to the switch blocks 39, 40 in FIG. 3 are the selection inputs and the connecting line in the middle is the condition input.

A comparison block 41 represents a function that outputs a result of comparison of two inputs as a value of 1 and 0 toward the later step. The value 1 indicates that a first input is greater than a second input, and the value 0 indicates otherwise.

An output block 42 represents a function that outputs data toward an outside of the model.

The model comprising blocks 31 to 42 and connecting lines between the blocks in FIG. 3 represents a function of a system that works in the following manner. That is, the switch block 39 continues to output an incremental value that increases in a step of 1 in an interval defined by the delay block 38 while the input data to the input block 31 does not take a value of 1. The model outputs a value of 760 from the constant block 35 while the output from the switch block is under a value of 1000. The model outputs a value of the input to the input block 32 from outside of the model. An input value of 1 to the input block 31 initializes the output of the switch block 39 to a value of 1.

In this manner, the model represents a function such as a relation between the input and output of the model by connecting blocks with the connecting lines.

The model in the present embodiment accepts an upper limit, a lower limit and an accuracy of the input data specified in a predetermined format. For example, the developer may use the model editor to input an additional value to a block. In this case, the predetermined format indicates an item in the additional value in the block. The additional value is not reflected in a process in the C source code generated by the automatic code generation program 110.

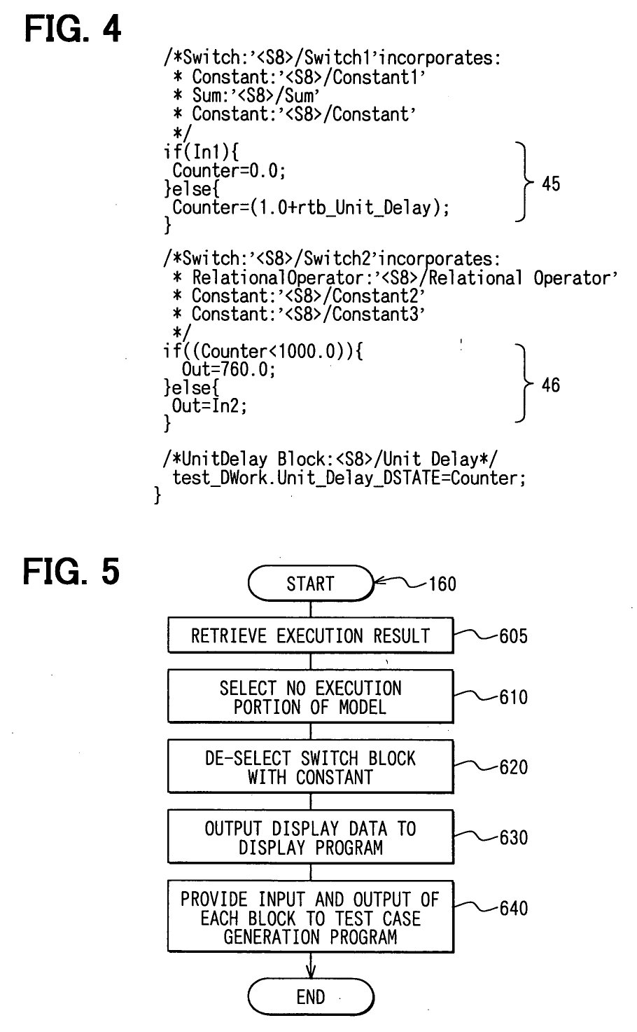

FIG. 4 shows the C source code generated by the automatic code generation program 110 based on the model shown in FIG. 3. In the C source code, the input blocks 31, 32 are stated as variables “In1 ” and “In2,” the output block 42 is stated as a variable “Out,” the function of the switch block 39 is stated as an “if” block 45, and the function of the switch block 40, the comparison block 41 and the output block 42 is stated as the “if” block 46.

The model information retrieval program 120 retrieves the model 210 from the HDD 15, and passes the retrieved data such as the upper limit, the lower limit and the accuracy in the blocks in the model to the automatic test case generation program 130 for generating the C source code. In this case, passing the data from one program to another program indicates that the data is stored in the HDD 15 or in the RAM 13 by the sending-the-data program in a predetermined format (using an area of storage and a file name) that is compatible with a destination program.

The automatic test case generation program 130 creates a test case 230 and stores it in the HDD15. The test case 230 is created based on the data from a simulation result analysis program 160 and the model information retrieval program 120, and also on the source code generated by the automatic code generation program 110. A test case is, in this case, a set of test data that is used as an input data to the source code in order to fully evaluate the quality of a program such as the C source code by exhaustively executing statements in the program. The quality of the program can be fully evaluated when the test case executes or “covers” all of the statements in the program exhaustively when, for example, a “coverage test” is executed. The quality of the program may be evaluated as the generated C source code as a whole, or may be evaluated as a portion of the program, that is, an execution unit such as a statement in the program. An input data, in this case, is the data that is used as an input data to the portion of the program under evaluation. Details of the automatic test case generation program 130 are described later. Portions of the model may be considered as a model because the portion of the model is a combination of the blocks and the connecting lines.

The C source code execution program 140 executes the C source code generated by the automatic code generation program 110 as the execution unit. The C source code is evaluated through execution of the test case 230 that is generated by the automatic test case generation program 130. Then, the C source code execution program 140 records a result of execution such as the output and an order of execution of the statements as an execution result 240 in the HDD 15.

The model simulation program 150 retrieves the model 210 from the HDD 15 to execute simulation of the model 210 on the personal computer 1. The simulation is, in this case, an execution of the input and the output of the data for a model reproduced in the personal computer 1. The simulation may be executed for the entire model or a portion of the model.

A portion of the source code executed by the C source code execution program 140 corresponds to a portion of the model executed by the model simulation program 150. In this manner, a portion of the generated C source code can be compared and evaluated by simulating a portion of the model.

The test case 230 is used as the data of an external input in the simulation of the source code. The result of the simulation, that is, the data outputted to an external system and the input and output of each block with execution time, is recorded as the execution result 240 in the HDD 15. The execution result 240 is used by the simulation result analysis program 160. The execution result 240 includes information on a choice of selection inputs by the switch blocks 39, 40.

The simulation result analysis program 160 analyzes the results of the simulation and evaluates appropriateness of the C source code generated by the automatic code generation program 110. The analysis program 160 further generates data for test case generation. The data for test case generation is used by the automatic test case generation program 130. Details of the process of the simulation result analysis program 160 are described later.

The execution result comparison program 170 compares the execution result 240 in the HDD 15 generated by the C source code execution program 140 and the model simulation program 150. The result of the comparison is used by the result display program 180. The comparison is, in this case, a comparison of two sets of data, that is, the data outputted from execution of the model by the model simulation program 150 and the other data outputted from execution of the C source code generated by the automatic code generation program 110. The comparison is made on output data from the same input data, that is, an output from the model and an output from the C source code. The execution result comparison program 170 evaluates the result of the comparison and determines whether the result passes test criteria. The evaluation is used by the result display program 180.

The result display program 180 displays the result of the evaluation on the display 11.

The process of the simulation result analysis program 160 is described with reference to the flowchart.

FIG. 5 shows the flowchart of the analysis program 160. The program 160 retrieves the execution result from the model simulation program 150 in step S605.

The program 160 selects a portion of the model that is not executed in the simulation in step S610. The portion of the model not being executed indicates that a block having no execution time and a switch block having a selection input with no record of input.

The program 160 de-selects a portion of the model that corresponds to the switch block having a selection input with no record of input because the input is a constant in step S620. The portion of the model may be sifted out by choosing the selection input connected to a constant block by the connecting line.

A portion of the source code seemingly not appropriately generated is chosen by selecting the portion of the source code with no execution record and by further de-selecting the switch block portion having the constant input in the above-described manner.

The lack of appropriateness of the portion of the source code is perceived based on the assumption that the test case should cover, i.e., execute, all branches and statements in the C source code. That is, the automatic code generation program 110 seems to be not appropriately handling the portion of the model for generating the C source code. In this case, the portion of the constant block is excluded because the input from the constant block is not recorded regardless of the test case.

In step S630, the program 160 determines if there is an inappropriate portion in the C source code based on the process in steps S610 and S620. If the inappropriate portion exists in the source code, the program 160 outputs the data for displaying inappropriateness to the result display program 180.

In step S640, the program 160 provides the input and output portion of the execution result of each block retrieved in step S605 to the test case generation program 130. This step concludes the process of the simulation result analysis program 160.

Details of the automatic test case generation program 130 are described with reference to the flowchart. The program 130 retrieves execution portion of the C source code 220 from the HDD 15 for generating the test case in step S405.

In step S410, the retrieved C source code is analyzed. More practically, the program 130 identifies number and type of external inputs to the code through arguments of a function, branch conditions in the code and variation of the branch conditions in this step.

In step S420, the program 130 retrieves the information on the model, that is, the upper and lower limits and the accuracy of the input data for the execution portion of the C source code 220.

In step S430, the program 130 retrieves the execution result of the model, that is, the data of the execution result of each block provided in step S640 by the simulation result analysis program 160.

In step S440, the program 130 generates the test case based on the result of the analysis in step S410 as well as the information of the model and the analysis of the execution result. More practically, the program 130 generates a set of the input data that exhaustively covers the branch conditions in the C source code based on the analysis in step S410.

The program 130 examines the set of the input data based on the information on the model retrieved in step S420. That is, the input value in the data is examined to see whether the value is within a range between the upper and lower limits. The input value will be changed to be within boundaries, that is, between the upper and lower limits, when the value exceeds the boundaries. The changed value will be carefully chosen so that coverage of the test will not be decreased, or decrease of the coverage will be minimum.

Further, branch conditions of the input value are examined in terms of the accuracy of the input value. That is, a branch condition, for example, of 0.5 is examined by including the value of 0.51 and 0.49 when the accuracy of the input is specified as 0.01. In this manner, the test case successfully includes the data that examines the branch condition.

Further, boundary conditions of the input value are examined so that the test case always includes the boundary conditions based on the execution result of the model. That is, the program 130 determines the portion of the input data retrieved in step S430 and used for generating the portion of the C source code, and then identifies the upper and lower limits of the value. The values of the data beyond the limits, i.e., the boundaries, are changed to be within the boundaries. The changed value will be carefully chosen for not narrowing the test coverage. The execution result of the model may selectively be used for generating the test case. That is, the user can choose whether the program 130 uses the execution result for test case generation.

In step S450, the program 130 stores the test case 230 in the HDD 15. The test case generation program 130 concludes the process in this step.

Then, the result display program 180 displays the result of comparison on the display 11 as shown is FIG. 7.

The result of the comparison includes two parts, that is, a comparison part 51 and a determination part 52. The comparison part 51 is a table of comparison that lists the data received from the comparison program 170 such as the input value “In1” and “In2,” “Out” value from the model, the output value from the C source code, difference of the output value between the model and the source code and consistency of the two outputs.

The determination part 52 displays the data received from the simulation result analysis program 160. The appropriateness of the generated test case based on the C source code is shown in this part by an “OK” sign if the process of the code is determined as appropriate, or by a “NG” sign if the process of the source code is determined as not appropriate.

The procedure according to the above description is summarized in the following twelve steps. The procedure may be executed automatically by using a program stored in the HDD 15, or may be executed manually by the input of the user from the input device 12.

Step 1: generating the C source code 220 from the model 210 by the automatic code generation program 110;

Step 2: retrieving the information on the model 210 by the model information retrieval program 120;

Step 3: generating the test case 230 based on the entire C source code 220 and the output of the model information retrieval program 120 by the automatic test case generation program 130;

Step 4: simulating the model 210 by the model simulation program 150;

Step 5: analyzing the simulation result (in steps S605 to S640) by the simulation result analysis program 160, and storing the information on the input and output data of each block of the model 210 in the HDD 15;

Step 6: generating the test case 230′ (230 apostrophe) for an execution unit (e.g., a function) in the C source code 220 by the automatic test case generation program 130 based on the C source code 220, the output of the information retrieval program 120 and the output of the simulation result analysis program 160;

Step 7: executing the execution unit of the C source code 220 used in Step 6 by the C source code execution program 140 (the test case 230′ is used as the input to the execution unit);

Step 8: simulating the portion of the model 210 that corresponds to the execution unit used in Step 6 by the model simulation program 150;

Step 9: analyzing the simulation result in Step 8, and storing the information on the input and output data of each block in the portion of the model 210 in the HDD 15 (the portion of the model 210 corresponds to the execution unit in Step 7);

Step 10: executing the C source code by the C source code execution program 140 using the test case 230, and storing the execution result in the HDD 15.

Step 11: comparing the simulation result of the model 210 and the execution result of the generated source code 240 by the execution result comparison program 170;

Step 12: displaying the comparison result from the simulation result analysis program 160 and the execution result comparison program 170 by the result display program 180.

Steps 6 to 9 may be iterated in plural times. Number of iteration may be a predetermined number (e.g., 5), or by the time when difference in the result of execution of the two successive test cases becomes less than a predetermined criterion.

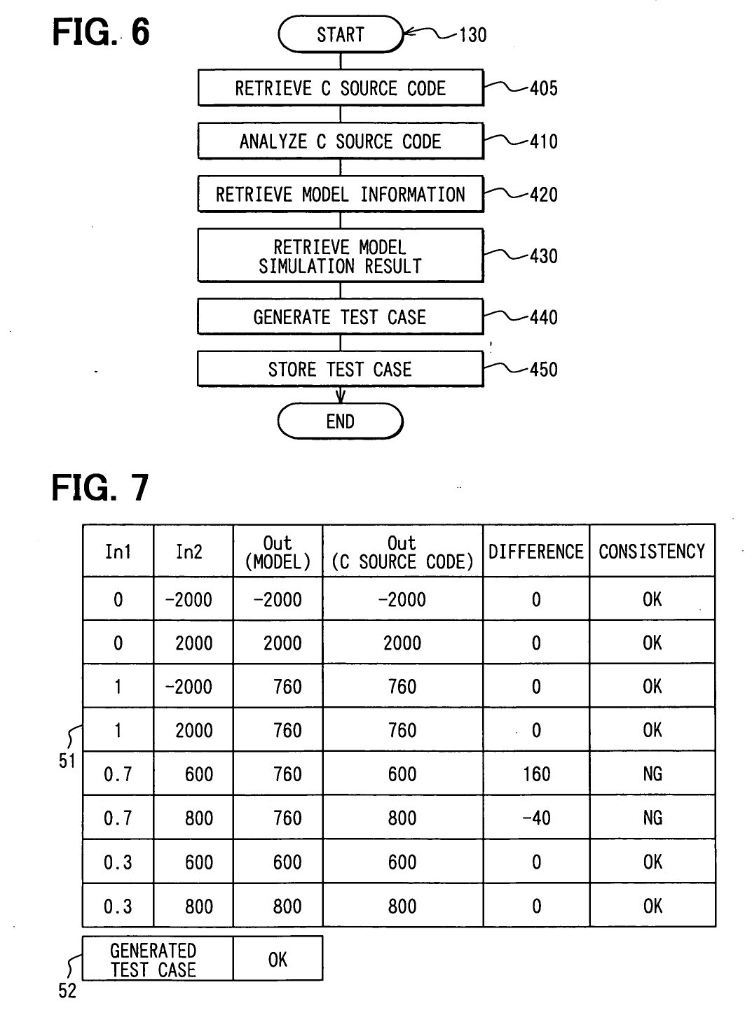

As a result, the personal computer 1 uses the programs for the model based development environment 100 to retrieve the source code (step S405 in FIG. 6) generated from the model, to retrieve the boundary conditions and the accuracy (step S420 in FIG. 6) to retrieve the simulation result of the model (step S430 in FIG. 6) and to generate the test case for the source code (step S440 in FIG. 6) based on the process in the retrieved source code and the analysis of the simulation result.

The test case generated in the above-described manner reflects not only the content, i.e., the statements, of the source code but also the information on the input data of the model and the analysis of the execution result of the model. Therefore, the test case generated by using the method in the present invention highly comprehensively reflects an intended specification embedded in the model by the developer.

Although the present invention has been fully described in connection with the preferred embodiments thereof with reference to the accompanying drawings, it is to be noted that various changes and modifications will become apparent to those skilled in the art.

For example, the test case generated in the present embodiment uses the information on the input data of the model besides the content of the source code. However, the information on each block in FIG. 3 and information on the connecting lines may be reflected in the test case.

Further, the simulation result analysis program 160 outputs the determined result of appropriateness to the result display program 180. However, the inappropriate portion of the model identified in steps S610 and S620 may be sent to the result display program 180 in step S630 for the ease of identification. In this manner, the inappropriate portion can easily be identified and corrected.

Such changes and modifications are to be understood as being within the scope of the present invention as defined by the appended claims.

What is claimed is:

1. A method for generating a test case for a source code used in a computer comprising the steps of:
retrieving the source code generated from a model definition of a control process accepting an input data;
retrieving model information in the model definition; and
generating the test case based on the source code and the model information.

2. The method according to claim 1,
wherein the model information includes at least one of a maximum value and a minimum value of the input data.

3. The method according to claim 2,
wherein the model information includes an accuracy of the input data.

4. A test case generation system in a computer comprising:
a source code retrieving means for retrieving a source code generated from a model definition of a control operation accepting an input data;
a model information retrieving means for retrieving model information in the model definition; and
a test case generation means for generating a test case based on the source code and the model definition.

5. A test case generation program comprising a computer usable medium having a computer program logic recorded thereon for enabling generation of a test case for a source code in a computer, the program logic comprising:
a source code retrieval procedure for retrieving the source code generated from a model definition of a control process accepting an input data;
a model information retrieval procedure for retrieving model information in the model definition; and
a test case generation procedure for generating a test case based on the source code and the model definition.

6. A method for generating a test case for a source code used in a computer comprising the steps of:
retrieving the source code generated from a model definition of a control process accepting an input data;
retrieving simulation result information generated from a simulation of the model definition; and
generating the test case based on the source code and the simulation result information.

7. The method according to claim 6,
wherein the model definition uses an output data of a model definition in a preceding step as the input data; and
the simulation result information includes the output data of the model definition in the preceding step.

8. The method according to claim 7,
wherein the output data includes at least one of a maximum value and a minimum value of the output data.

9. A test case generation system in a computer comprising:
a source code retrieving means for retrieving a source code generated from a model definition of a control operation accepting an input data;
a simulation result information retrieving means for retrieving simulation result information generated from a simulation of the model definition; and
a test case generation means for generating a test case based on the source code and the simulation result information.

10. A test case generation program comprising a computer usable medium having a computer program logic recorded thereon for enabling generation of a test case for a source code in a computer, the program logic comprising:
a source code retrieval procedure for retrieving the source code generated from a model definition of a control process accepting an input data;
a simulation result information retrieval procedure for retrieving simulation result information generated from a simulation of the model definition; and
a test case generation procedure for generating a test case based on the source code and the simulation result information.

11. A method for determining appropriateness of a generated source code based on a model definition of a control process used in a computer comprising the steps of:
retrieving simulation result information from a simulation of the model definition having a test case for the generated source code as an input data for the simulation; and
storing evaluation information based on the simulation result information.

12. The method according to claim 11,
wherein the simulation result information includes information on a portion of the model definition that is not executed in the simulation.

13. A method for a model based software development enabling generation of a test case used in a computer comprising the steps of:
generating a source code base on a model definition of a control process;
retrieving the source code;
retrieving model information in the model definition;
generating a test case based on the source code and the model information; and
executing a simulation of the model definition using the test case as an input data.

14. A method for a model based software development enabling generation of a test case used in a computer comprising the steps of:
generating a source code base on a model definition of a control process;
executing a simulation of the model definition;
analyzing a simulation result information of the simulation;
retrieving the source code generated from the model definition;
retrieving the analyzed simulation result information; and
generating a test case based on the source code and the analyzed simulation result information.

15. A model based software development system for generating a source code used in a computer comprising:
a retrieving means for retrieving simulation result information generated from a simulation of a model definition of a control operation, the simulation using a test case based on the source code generated from the model definition as an input data; and
a storing means for storing evaluation information based on the simulation result information.

16. The model based software development system according to claim 15 further comprising a display means for displaying the evaluation information on a display.

17. A model based software development program comprising a computer usable medium having a computer program logic recorded thereon for enabling evaluation of a source code in a computer comprising:
a retrieving procedure for retrieving simulation result information generated from a simulation of a model definition of a control process, the simulation using a test case based on the source code generated from the model definition as an input data; and
a storing procedure for storing evaluation information based on the simulation result information.

18. The model based software development program according to claim 17 further comprising a display procedure for displaying the evaluation information on a display.
